(19) United States
(12) Patent Application Publication
(10) Pub. No.: US 2019/0333352 A1
(43) Pub. Date: Oct. 31, 2019

(54) Security camera mounted in ornamental fish

(71) Applicant: Aaron Escobar, Bay City, TX (US)

(72) Inventor: Aaron Escobar, Bay City, TX (US)

(21) Appl. No.: 15/965,940

(22) Filed: Apr. 29, 2018

(51) Int. Cl. G08B 13/196; G03B 29/00; G08B 15/00

(52) U.S. Cl. CPC G08B 13/19619; H04N 7/185; G08B 15/001; G03B 29/00

(57) ABSTRACT

The invention is a security camera mounted in an ornamental fish. The fish is intended for mounting on the user's wall to provide a good field of vision, and provides a security camera mounted in the eye. One or more motion sensors are also provided, which activate the camera and transmit an alert signal to the user's smartphone or other mobile electronic device. A mobile application is also provided, which may be used to remotely activate the camera, contact a law enforcement agency, and preserve one or more digital video recordings.

### CROSS-REFERENCE TO RELATED APPLICATIONS

This application relates back to, and claims the priority of Provisional Patent Application No. 62/502,580 filed on May 5, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to video security systems and components, and in particular to a security camera mounted in an ornamental fish. Many sport fishermen and hunters have accumulated valuable collections of equipment that are tempting targets for thieves. Firearms, expensive fishing rods, fishing tackle, and camping equipment are generally stored in one room and designed to be easily carried, and thus are easily carried away by burglars. Conventional security cameras are easily spotted and disabled, and more sophisticated security systems are often prohibitively expensive. A security camera that is concealed in a conventional looking object and alerts the user to motion in the storage room would be very useful, and would be well received.

A search of the prior art reveals various devices which have been developed to provide the features of a camera, which is concealed within an ordinary and inobtrusive household object. None are closely related to the present invention, but several include features which resemble those of the present invention. Each has proven to be less than satisfactory for the present purpose in its own way.

Discrete surveillance camera devices, U.S. Pat. No. 6,249,310 (priority Dec. 11, 1995), provides a discrete surveillance device for observing a surveillance location has a housing formed in the shape of a smoke detector and multiple miniature video surveillance cameras mounted within the housing to simultaneously observe multiple areas of the surveillance location. The surveillance cameras are concealed in the housing from an observer viewing the exterior of the housing. Further discrete surveillance devices include a face plate or housing having a clock exterior with a miniature video surveillance camera mounted on an adjustable camera gimbal attached to the back surface of the face plate or clock. The surveillance camera is concealed from an observer viewing the exterior surface of the face plate or clock.

Concealment of cameras for observational purposes, U.S. Pat. No. 3,739,703 (priority Mar. 9, 1970), provides a camera for observing a selected area, which is concealed by a hollow dome-like member partially metallised to form a convex mirror from the point of view of an observer in the selected area, while allowing light to pass through the member from the area to the camera.

Sequentially operable hidden camera device, U.S. Pat. No. 3,672,269 (priority Apr. 8, 1970), provides a sequentially operable hidden camera device, enclosing a camera therein with means to conceal the presence of the camera from the view of intruders, and which will trigger the camera by connection to an intruder detection system, to cause the camera to take a series of pictures of the intruder for identification purposes, and to deter the intruder by flashes connected with the operation thereof.

Surveillance camera system, U.S. Pat. No. 4,945,367 (priority Mar. 2, 1988), provides a surveillance camera system comprising a spherical housing that has a partially transparent lower, hemispherically shaped gold coated dome with a geometric center. A camera mount is mounted in the housing for panning movements about a vertical pan axis and tilting movement about a horizontal tilt axis. A video camera is mounted to the camera mount and electric motors are mounted for panning and tilting the mount and camera. A computer and control circuit is mounted to the camera mount and coupled to actuate the electric motors to orient the camera and to actuate the camera zoom and focus as well as to enhance the camera's video image with descriptive word captions. The computer is programmed for automatic or manual operation of the system. A rotary electric connector is mounted to the housing and connects the on board computer with a joystick and control unit for issuing instructions to the computer and connects the camera to an ancillary video display. (Note: See also U.S. Pat. Nos. 5,111,288 & 4,918,473.)

Hidden camera disguised as tissue box, U.S. Pat. No. 7,848,637 (priority Jan. 23, 2009), provides a hidden camera disguised as a tissue box so as for the hidden camera to have the semblance of a tissue box. The invention is comprised of a base, a casing engaged with and fixed in position to the base, a battery chamber, a supporter positioned above the battery chamber and configured to support a tissue pack, and a camera unit including a lens unit and a printed circuit board. The lens unit includes a lens positioned immediately behind a lens aperture of the casing.

The purpose of the present invention is to correct the deficiencies in the existing inventions cited herein, and thereby provide a substantial improvement over all the prior art. A security camera mounted in an ornamental fish, which is mounted on the wall to provide an excellent field of vision and provides a camera in the eye of the fish, would resolve this problem.

### SUMMARY OF THE INVENTION

Accordingly, the invention is a security camera mounted in an ornamental fish. The fish is intended for mounting on the user's wall to provide a good field of vision, and provides a security camera mounted in the eye. One or more motion sensors are also provided, which activate the camera and transmit an alert signal to the user's smartphone or other mobile electronic device. A mobile application is also provided, which may be used to remotely activate the camera, contact a law enforcement agency, and preserve one or more digital video recordings.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment, displaying the mounting board 10, the fish 11, and the camera 12.

FIG. 2 is a bottom view of the first exemplary embodiment, displaying the mounting board 10, the fish 11, and the main body 13.

FIG. 3 is a bottom view of the first exemplary embodiment, displaying the mounting board 10, and the fish 11.

FIG. 4 is a front perspective view of the first exemplary embodiment, displaying the mounting board 10, the fish 11, and the camera 12.

FIG. 5 is a front view of the electronic components of the first exemplary embodiment, displaying the camera 12, the main body 13, and the cable 14.

FIG. 6 is a side perspective view of the first exemplary embodiment, displaying the mounting board 10, the fish 11, and the camera 12.

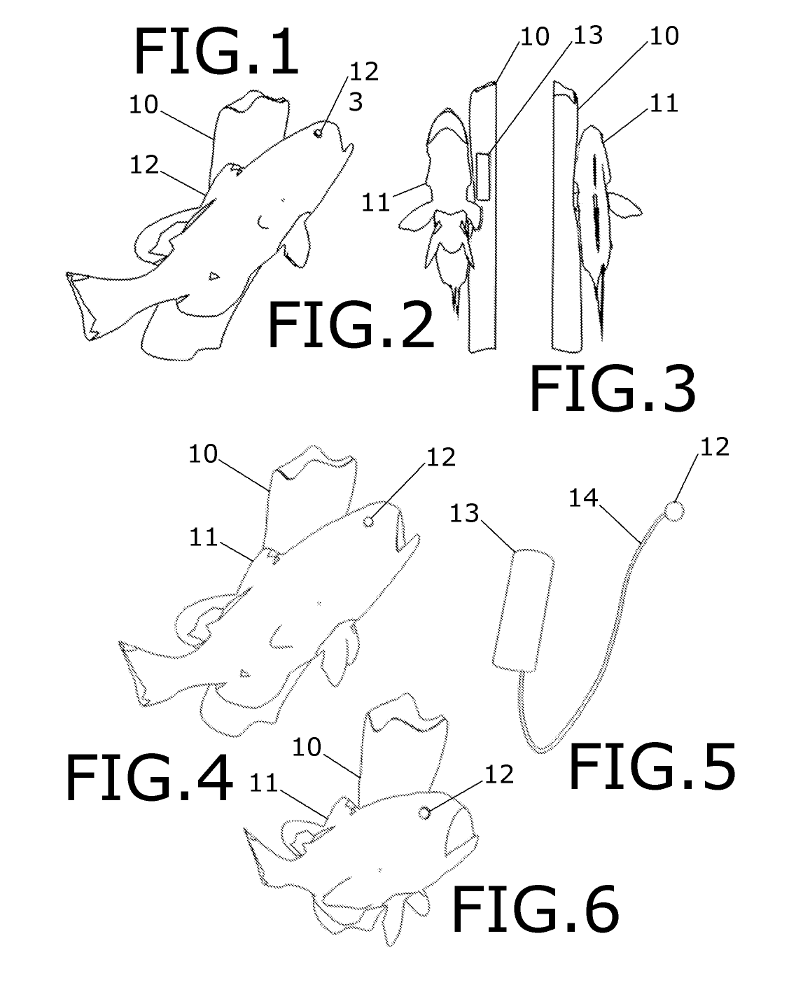

### DETAILED DESCRIPTION OF THE INVENTION

Referring now to the invention in more detail, the invention is a security camera mounted in an ornamental fish.

It is to be understood that while the invention is intended for use in a large freshwater game fish, such as a bass or a trout, this is not intended as a limitation. With suitable modification or with no modification at all, the invention may be used with any taxidermy product or sculpted animal or animal part suitable for mounting on a wall or shelf, such as a deer head or a ceramic eagle sculpture.

The first exemplary embodiment is comprised of an ornamental fish 11 on a mounting board 10. The fish 11 is preferably a large freshwater game fish, such as a bass or trout. The fish 11 is intended for mounting on a wall to monitor the contents of a room. The wall mounting provides a good field of vision for a security camera 12 which is provided in the eye of the fish 11.

The fish 11 provides a concealed main body 13, which is connected to the camera 12 via a cable 14. The main body 13 provides electronic components and a battery. One or more motion sensors are also provided, which activate the camera 12 and transmit an alert signal via WiFi™ or a similar data communications protocol to the user's smartphone or other mobile electronic device. A mobile application is also provided, which may be used to remotely activate the camera 12, contact a law enforcement agency, and preserve one or more digital video recordings.

To use the first exemplary embodiment, the user may mount the fish 11 on the wall of a room to be protected, download and install the application on a smartphone or other mobile electronic device, and synchronize the application with the main body 13. Upon receiving an alert signal from the main body 13 on the electronic device, the user may use the application to observe the protected room and, if appropriate, contact a law enforcement agency or preserve one or more digital video recordings of activity in the protected room.

Electronic components of the main body 13 preferable include a transceiver capable of transmitting and receiving via WiFi™ or a similar data communications protocol, a microprocessor, a memory device, and one or more replaceable batteries.

The mounting board 10 is preferably manufactured from a rigid, durable material, such as plastic or hardwood. Preferably, the fish 11 is a taxidermy trophy. Alternately, the fish 10 may be manufactured from a rigid, durable material such as hand-painted plastic or fiberglass.

The camera 12 and the main body 13 are preferably manufactured from rigid, durable materials such as steel, aluminum alloy, brass, and plastic. The cable 14 is preferably manufactured from braided copper alloy wire sheathed in plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. A security system, comprising:
a mounting board secured to a wall, the mounting board having a main body that is concealed within the mounting board and which houses electronic components operating a security camera, the electronic components including at least a replaceable battery and a transceiver to receive and transmit signals;
an ornamental fish that is mounted on the mounting board;
the security camera mounted in an eye of the ornamental fish;
a cable that extends from the security camera and leads to the electronic components in the main body;
a motion sensor that triggers operation of the security camera responsive to detecting motion in a physical environment surrounding the ornamental fish; and
a mobile application instantiated on a mobile electronic device that interoperates with the security camera on the ornamental fish, wherein the mobile application enables a user to receive video recordings from the security camera responsive to the motion sensor triggering operation of the security camera when motion is detected, and wherein the mobile application enables the user to remotely activate the security camera.

2. The security system of claim 1, wherein the mounting board is mounted on a wall to enable the security camera in the eye of the ornamental fish to monitor the contents of a room.

3. (canceled)

4. The security system of claim 1, wherein the transceiver transmits an alert signal via WiFi™ to the user's smartphone or other mobile electronic device.

5. The security system of claim 1, wherein the mobile application is further configured to contact a law enforcement agency and preserve one or more digital video recordings captured by the security camera.

6. The security system of claim 5, wherein the mobile application synchronizes with the security camera of the ornamental fish.

7. The security system of claim 4, wherein the security camera transmits the alert signal to the mobile electronic device responsively to detecting motion using the motion sensor.

8. The security system of claim 1, wherein the main body further includes:
a microprocessor, and
a memory device.

9. The security system of claim 1, wherein the mounting board is comprised of a rigid, durable material, including plastic or hardwood.

10. The security system of claim 1, wherein the fish is a taxidermy trophy and alternately, the fish may be manufactured is comprised of a rigid, durable material including hand-painted plastic or fiberglass.

11. The security system of claim 3, wherein the main body is comprised of rigid, durable materials including steel, aluminum alloy, brass, and plastic.

12. The security system of claim 3, wherein the cable is braided copper alloy wire sheathed in plastic.

13. The security system of claim 1, wherein the cable extends from the ornamental fish, through the mounting board, and to the main body inside the mounting board.
